(19) United States
(12) Patent Application Publication
(10) Pub. No.: US 2014/0321040 A1
(43) Pub. Date: Oct. 30, 2014

(54) ACCESSORY CONNECTOR FOR AN ELECTRONIC DEVICE

(71) Applicant: RESEARCH IN MOTION LIMITED, Waterloo (CA)

(72) Inventors: Ryan James RUTTER, Kitchener (CA); Dustin Jonathan SMITH, Chicago, IL (US); Ian James MURCHISON, Ottawa (CA); Jason Tyler GRIFFIN, Kitchener (CA); Anders FAHRENDORFF, Ottawa (CA)

(73) Assignee: Research In Motion Limited, Waterloo, ON (CA)

(21) Appl. No.: 13/869,723

(22) Filed: Apr. 24, 2013

(51) Int. Cl. G06F 1/16

(52) U.S. Cl. CPC G06F 1/1633
USPC 361/679.26; 361/679.55; 361/679.4

(57) ABSTRACT

An electronic device includes at least one connector, such as for physically coupling the electronic device to a device accessory. The connector includes a coupling element movable between a retracted position and an extended position in response to a magnetic force that exceeds a biasing force applied to the coupling element by a biasing element.

### TECHNICAL FIELD

The present application relates to connectors for physically connecting electronic devices to accessories and connectors for physically and electrically connecting electronic devices to accessories.

### BACKGROUND DISCUSSION

The rapid advancement of portable electronic device technology has resulted in devices becoming smaller while device functionality has increased. In addition to including the latest features, portable electronic devices must be visually appealing in order to be successful products in the marketplace.

Some of the increased functionality is achieved by connecting the devices to accessories, such as external keyboards, external speakers or mounting devices, for example. In many portable electronic devices, connection is achieved by using external connectors for physically coupling the portable electronic device to an accessory. In some cases, the external connectors detract from the sleek, streamlined look that is desirable in most devices.

### BRIEF DESCRIPTION OF THE DRAWINGS

Embodiments of the present application will now be described, by way of example only, with reference to the attached Figures, wherein:

FIG. 1 is a simplified block diagram of one example of a portable electronic device in accordance with the present disclosure;

FIG. 2 is a rear isometric view of a portable electronic device including connectors that are shown in a retracted position;

FIG. 3 is a rear isometric view of the portable electronic device of FIG. 2 in which the connectors are shown in an extended position;

FIG. 4 is a rear view of the portable electronic device of FIG. 2;

FIG. 5 is a simplified view on 5-5 of FIG. 4 depicting the retracted position of a connector;

FIG. 6 is a simplified view on 5-5 of FIG. 4 depicting the extended position of a connector;

FIG. 7 is a rear isometric view of the portable electronic device coupled to an example accessory;

FIG. 8 is a schematic view of a connector of the portable electronic device prior to engagement with the accessory of FIG. 7;

FIG. 9 is an isometric view of a fitting for an accessory;

FIG. 10 is a schematic side view of a connector for mating with the fitting of FIG. 9;

FIG. 11 is a side schematic view of the connector of FIG. 10 partially engaged with the fitting of FIG. 9;

FIG. 12 is a side schematic view of the connector of FIG. 10 fully engaged with the fitting of FIG. 9;

FIG. 13 is a rear isometric view of the portable electronic device coupled to another example accessory;

FIG. 14 is a rear isometric view of the portable electronic device coupled to yet another example accessory;

FIG. 15 is a rear isometric view of the portable electronic device coupled to still another example accessory;

FIG. 16 is an isometric view of a connector according to another embodiment showing the connector in the retracted position;

FIG. 17 is an isometric view of the connector of FIG. 16 showing the connector in the extended position;

FIG. 18 is an isometric view of a connector according to yet another embodiment showing the connector in the retracted position;

FIG. 19 is a side sectional view of the connector of FIG. 18; and

FIG. 20 is a side sectional view similar to FIG. 19 showing the connector in the extended position.

### DETAILED DESCRIPTION

The disclosure generally relates to coupling members that can assist in physically or mechanically connecting or coupling one component to another. The coupling members themselves need have no specific size or shape, but they may be thought of as being generally cylindrical in shape, and may be described in some embodiments as bolts, pins, rods, pegs, spindles, shafts, plugs, tubes, bars and the like. In some embodiments, the coupling members may conduct electrical signals (and may thereby offer mechanical and electrical connection), and may be thought of as terminals, conductors, conduits, prongs, jack plugs and the like. The apparatus described herein may be especially useful in the context of coupling an electronic device to an accessory, and so the concepts will generally be described in that context. The connector includes a coupling element movable between a retracted position and an extended position in response to a magnetic force that exceeds a biasing force applied to the coupling element by a biasing element.

Examples of electronic devices include wireless communication devices such as pagers, cellular phones, cellular smart-phones, wireless organizers, personal digital assistants, tablet computers, wirelessly enabled notebook computers, and so forth. The electronic device may be portable (readily movable from place to place) and may be handheld (sized and shaped to be held or carried in a human hand). The electronic device may also be a portable electronic device without wireless communication capabilities. An accessory generally is a hardware element or set of elements that can be used in conjunction with an electronic device. Examples of accessories for electronic devices include, but are not limited to, external keyboards, external speakers, game controllers, security locks, docking stations, docking stands, external displays, device cases, device covers, auxiliary batteries or power supplies, and charging devices. Accessories may include, but need not include, electronic components.

In an aspect of the disclosure there is provided an electronic device comprising: a housing; an aperture extending through a panel of the housing; a connector mounted within the housing, the connector comprising: a guide aligned with the aperture; a coupling member slidably received in the guide and movable between a retracted position in which a base end surface of the coupling member abuts a seat of the guide and an extended position, the coupling member biased toward the retracted position and the coupling member movable toward the extended position in response to a magnetic force that exceeds a biasing force applied by a biasing member, the coupling member retained in the guide when in the extended position. The connector may be used for coupling to a device accessory.

Other aspects and features of the present disclosure will become apparent to those ordinarily skilled in the art upon review of the following description of specific embodiments in conjunction with the accompanying figures.

For simplicity and clarity of illustration, reference numerals may be repeated among the figures to indicate corresponding or analogous elements. Numerous details are set forth to provide an understanding of the embodiments described herein. However, it will be understood by those of ordinary skill in the art that the embodiments described herein may be practiced without these details. In other instances, well-known methods, procedures and components have not been described in detail to avoid obscuring the embodiments described herein. The description is not to be considered as limiting the scope of the embodiments described herein.

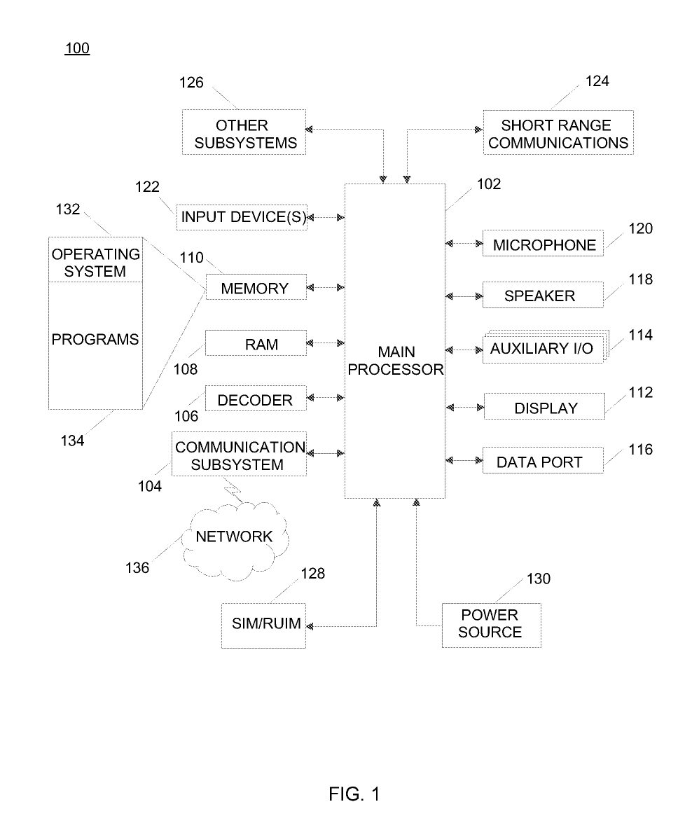

A block diagram of an example of a portable electronic device 100 is shown in FIG. 1. The portable electronic device 100 includes multiple components supported by a housing (not shown in FIG. 1), such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 136. The wireless network 136 may be any type of wireless network, including, but not limited to, data wireless networks, voice wireless networks, and networks that support both voice and data communications. A power source 130, such as one or more rechargeable batteries or a port to an external power supply, powers the portable electronic device 100.

The processor 102 interacts with other components, such as Random Access Memory (RAM) 108, memory 110, a display 112, an auxiliary input/output (I/O) subsystem 114, a data port 116, a speaker 118, a microphone 120, short-range communications 124, and other device subsystems 126. The auxiliary I/O subsystem 114 may include electrical connections that enable coupling of the portable electronic device 100 to one or more accessories. Information, such as text, characters, symbols, images, icons, and other items that may be displayed or rendered on a portable electronic device, is displayed on the display 112 via the processor 102.

To identify a subscriber for network access, the portable electronic device 100 uses a Subscriber Identity Module or a Removable User Identity Module (SIM/RUIM) card 128 for communication with a network, such as the wireless network 136. Alternatively, user identification information may be programmed into memory 110.

The portable electronic device 100 includes an operating system 132 and software programs or components 134 that are executed by the processor 102 and are typically stored in a persistent, updatable store such as the memory 110. Additional applications or programs may be loaded onto the portable electronic device 100 through the wireless network 136, the auxiliary I/O subsystem 114, the data port 116, the short-range communications subsystem 124, or any other suitable subsystem 126.

A received signal such as a text message, an e-mail message, or web page download is processed by the communication subsystem 104 and input to the processor 102. The processor 102 processes the received signal for output to the display 112 and/or to the auxiliary I/O subsystem 114. A subscriber may generate data items, for example e-mail messages, which may be transmitted over the wireless network 136 through the communication subsystem 104. For voice communications, the overall operation of the portable electronic device 100 is similar. The speaker 118 outputs audible information converted from electrical signals, and the microphone 120 converts audible information into electrical signals for processing.

The display 112 may be an LCD display and input may be received via input device(s) 122. Examples of input devices 122 include: a keyboard, a track pad, a touch pad or one or more buttons. A single input device 122 or any combination of input devices 122 may be used. Alternatively, the display 112 may be a touch-sensitive display, such as a capacitive touch-sensitive display or a resistive touch-sensitive display, for example. A capacitive touch-sensitive display may include a capacitive touch-sensitive overlay operably connected to an electronic controller, which communicates with processor 102. One or more touches, also known as touch contacts or touch events, may be detected by the touch-sensitive display. The processor 102 may determine attributes of the touch, including a location of a touch. The touch-sensitive display may also be configured to detect a gesture. A gesture, such as a swipe, is a type of touch that begins at an origin point and continues to a finishing point while touch contact is maintained. A touches and gestures may be detected from any suitable object, such as a finger, thumb, appendage, or other items, for example, a stylus, pen, or other pointer, depending on the nature of the touch-sensitive display. The components shown in FIG. 1 are for purposes of illustration; additional or fewer components may be included based on the functionality of the portable electronic device 100.

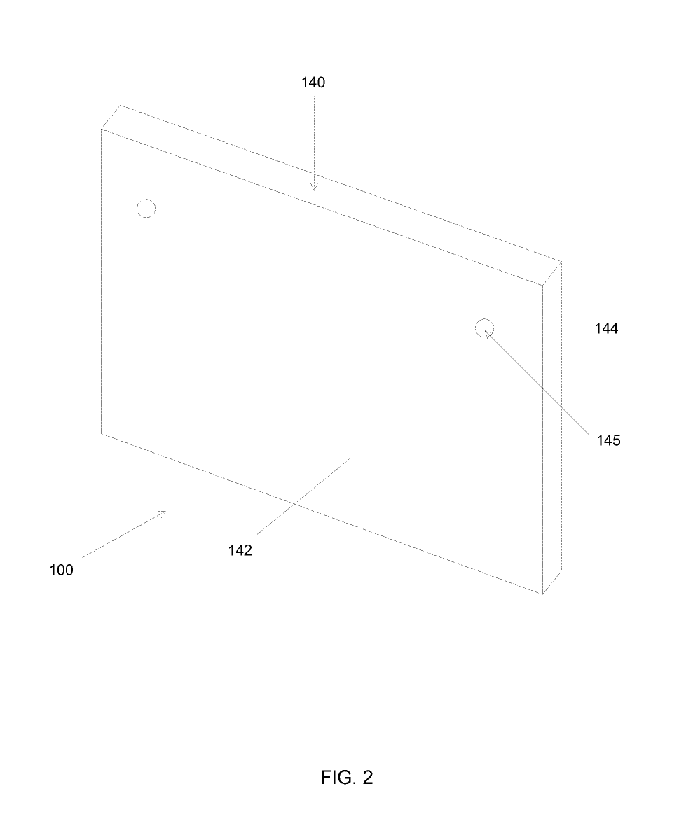

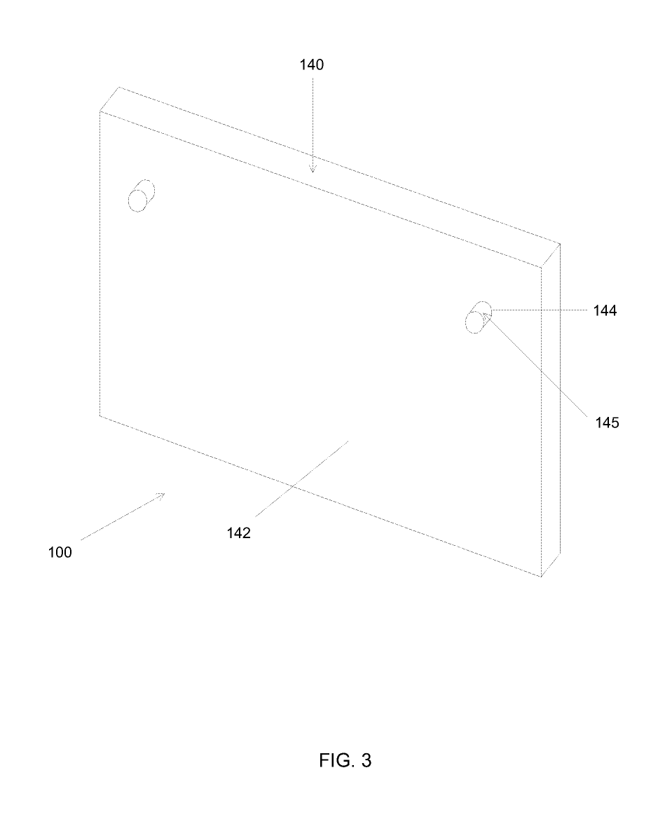

Referring to FIGS. 2 and 3, the portable electronic device 100 includes a housing 140 in which the components of FIG. 1 are supported. Generally speaking, the housing 140 houses the various components of the portable electronic device 100 and facilitates cooperation of the components to operate as a single device. The housing 140 may surround some of the components completely, or may leave components at least partly exposed. The housing 140 may serve as a foundation for mounting or securing electronic components, and may serve other functions as well, such as protecting the components from contaminants or impacts, or giving the portable electronic device 100 a pleasing appearance. The housing may be constructed from any material or combination of materials, such as metal, plastic, silicone, glass fiber, and the like. As will be described below, the housing 140 may further include one or more physical features that enable the operation of one or more connectors that may connect the portable electronic device 100 to one or more accessories. A back panel 142 of the housing 140 includes apertures 144 that are aligned with connectors 145 of the portable electronic device 100. That is, the housing 140 includes a surface or a panel that is discontinuous and defines one or more apertures, openings, holes, cutouts, recesses, or other voids, through which the connectors 145 can move. Apertures 144 extend through the back panel 142 in the sense that they can accommodate the connectors 145 and enable the connectors 145 (or the coupling members of the connectors, as will be described in more detail below) to extend and retract. It is not necessary that the housing 140 include through holes; for example, the housing 140 may include recesses or sockets that do not pass completely through the housing 140, yet the recesses or sockets can accommodate the connectors 145 and associated apparatus, if any, and can serve as guides as described below. The connectors 145 are movable from a retracted position, which is shown in FIG. 2, to an extended position, which is shown in FIG. 3. As shown in FIG. 2, when the connectors 145 are in the retracted position, the exposed surfaces of the connectors 145 are flush with the surface of the back panel 142. As used herein, “flush” includes strictly flush as well as substantially or approximately flush, in which a component may be slightly or negligibly extended or recessed with respect to a panel. Although depicted as planar, the back panel 142 may be curved. In the extended position, the connectors 145 may be used to couple the portable electronic device 100 to an accessory, such as a device case, a device cover, a device stand, a mounting device for a wall or a vehicle, for example, an external keyboard, an external display, an auxiliary battery, a charging device or a speaker, for example.

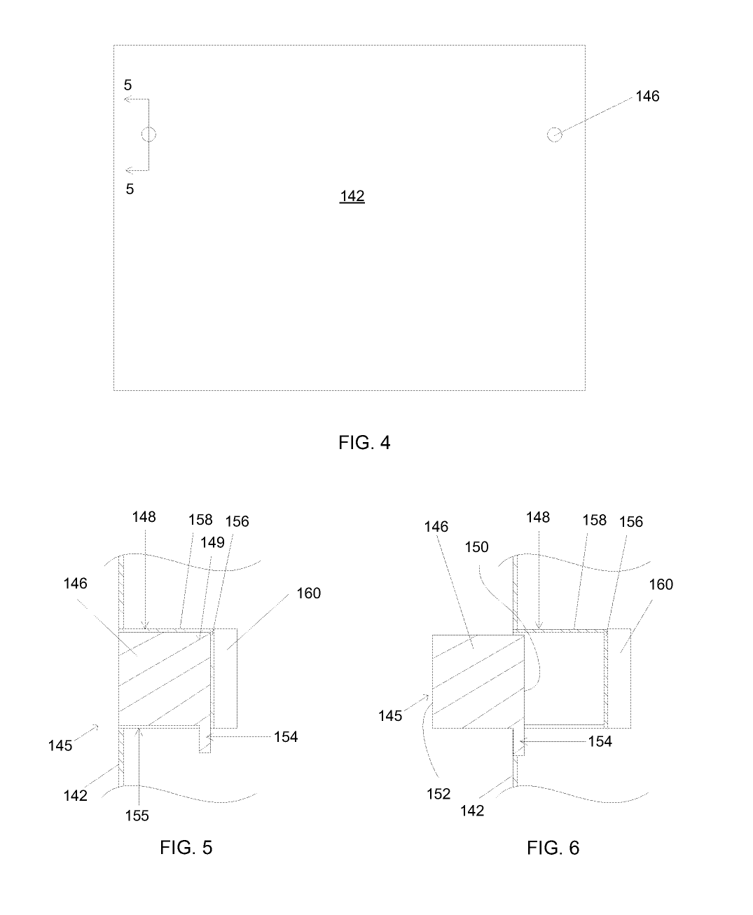

FIGS. 4, 5 and 6 show an illustrative embodiment of the connectors 145 depicted in FIGS. 2 and 3. The connectors 145 include coupling members 146 that are slidably received in guides 148. The guides 148 are mounted inside the housing 140 and are fixed relative to the back panel 142. The guides 148 may be coupled to an inner surface of the back panel 142, as shown in the example embodiment of FIGS. 4, 5 and 6 or coupled to a support that is mounted inside the housing 140, for example. The guides 148 may also be formed as a part of the housing 140.

In the example shown in FIGS. 2-6, two connectors 145, which are generally identical, are provided. In embodiments in which two or more connectors 145 are provided, the connectors 145 may be generally identical or may be different. Further, the connectors 145 may be positioned and spaced relative to one another in ways other than illustrated in FIGS. 2-6. A single connector 145 will now be described.

The coupling member 146 of the connector 145 may be generally cylindrical in shape and may include a circular cross-section. Although depicted as solid, the coupling member 146 may be hollow. The coupling member 146 includes a base 149, a base end surface 150 and an exposed end surface 152. A projection 154 extends from the base 149. A cross-sectional area of the base 149 at the location of the projection 154 is larger than a diameter of the aperture 144 of the back panel 142. Consequently, although the coupling member 146 may move relative to the back panel 142 of the housing 140, the coupling member 146 is prevented from separating completely from the housing 140. In other words, the projection 154, which cannot readily pass completely through the aperture 144, functions as a retainer to maintain the coupling member 146 at least partially within the housing 104 and in physical contact with the guide 148. In another embodiment, a different retaining structure may operate in concert with or may replace the projection 154. In a further embodiment, the projection 154 may be omitted and the biasing element may also function as a retainer to maintain the coupling element 146 within the housing 140 in communication with the guide 148. A spring, for example, may serve both as a biasing element and as a retainer that resists or prevents the coupling member 146 from separating completely from the housing 140. As will be discussed below, a spring made of a conducting material may also serve as a current path. In these ways, a single element may perform multiple functions.

The guide 148 is sized to slidably receive the coupling member 146. In other words, the coupling member 146 can move to the extended position or the retracted position relative to the guide 148. A seat 156 of the guide 148 limits movement of the coupling member 146 into the housing 140 of the portable electronic device 100. The seat 156 may be embodied as a flat surface (as shown in FIGS. 5 and 6) or as a surface of another shape, or a ridge, a flange, or a stop, for example. In general, the coupling member 146 abuts the seat 156 when the coupling member 146 is in the retracted position; colloquially, the seat 156 physically prevents the coupling member 146 from retracting any further. A wall 158 of the guide 148 is shaped to ensure that a travel path of the coupling member 146 between the retracted position and the extended position is generally linear. An opening 155 of the guide receives the projection 154. In the retracted position of FIG. 5, the exposed end surface 152 of the coupling member 146 is flush with an outer surface of the back panel 142. In the extended position of FIG. 6, the coupling member 146 projects from the back panel 142 of the housing 140.

The coupling member 146 may be made of a metal, which may include a ferrous material such as steel, for example. The coupling member 146 may be entirely made of a ferrous material or partially made of a ferrous material. A coating or other surface treatment may be applied to the coupling member 146 to match the colour and/or appearance of the housing 140 of the portable electronic device 100, for example. Example coatings include: plastic, physical vapor deposition (PVD) or powder coatings. Any coating that does substantially interfere with the magnetic attractiveness of the coupling member 146 may be used. In some embodiments, some interference by the coating or other surface treatment may be acceptable. In those embodiments, the effect of the interference may be factored into the design of the connector 145.

The connector 145 further includes a biasing member 160 that is mounted within the housing 140 adjacent to the seat 156 of the guide 148. In this example, the biasing member 160 is a magnet that biases the coupling member 146 toward the retracted position. Other types of biasing members may alternatively, or additionally, be included. For example, a spring (such as a coil spring or a leaf spring) may be coupled between the seat 156 of the guide 148 and the base end surface 150 of the coupling member 146.

In operation, the coupling member 146 of the portable electronic device 100 is movable from the retracted position to the extended position in response to a magnetic force generated by one or more external magnets. The external magnets are capable of generating a force that is greater than the force applied to the coupling member 146 by the biasing member 160 of the portable electronic device 100 in order to cause the coupling member 146 to move away from the seat 156 of the guide 148 and into the extended position. A retainer or retaining element, such as the projection 154, prevents the coupling member 146 from separating completely from the housing 140. Colloquially speaking, an external magnet can pull the coupling member 146 out, but not all the way out.

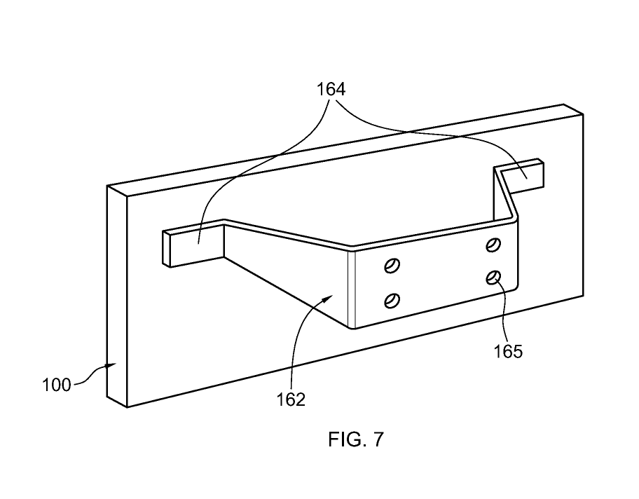

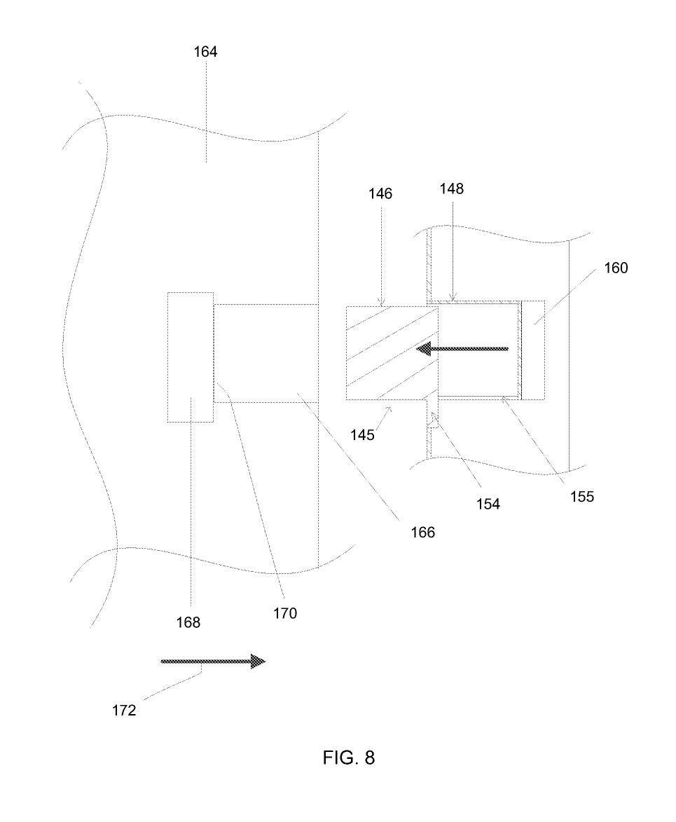

The external magnet may be included in an accessory, such as the mounting device 162 shown in FIG. 7. In this example, the mounting device 162 includes apertures 165 for receiving fasteners, which secure the mounting device 162 to a wall, for example. The mounting device 162 is arranged to receive two connectors 145 that are coupled to the back panel 142 of the portable electronic device 100. When the portable electronic device 100 is coupled to mounting device 162, the coupling members 146 are received in recesses 166 formed in connecting flanges 164 of the mounting device 162, one of the recesses 166 is shown in FIG. 8. The recess 166 is sized to receive the coupling member 146. An accessory magnet 168 is located adjacent to an end 170 of the recess 166, however, may alternatively be included at another location near the recess 166.

In order to physically couple the portable electronic device 100 to the mounting device 162, a user aligns the connectors 145 of the portable electronic device 100 with the recesses 166 and moves the connectors 145 toward the recesses 166, as indicated by arrow 172. When the portable electronic device 100 is sufficiently close, the force applied to the coupling member 146 by the accessory magnet 168 exceeds the biasing force applied to the coupling member 146 by the biasing member 160 and the coupling member 146 extends and is received in the recess 166 of the mounting device 162. In other words, the biasing member 160 may exert enough force to keep the coupling member 146 in the retracted position, but an external force can overcome the force of the biasing member 160, and cause the coupling member 146 to move into the extended position. Further, the external force may, hold the coupling member 146 in the extended position. When coupled to one another, the portable electronic device 100 and the mounting device 162 are held together by the relative force of the external magnet 168. Such coupling typically constrains the freedom of motion of the portable electronic device 100 with respect to the mounting device 162. The extension of the coupling member 146 into the recess 166, for example, may restrict sliding of the portable electronic device 100 with respect to the mounting device 162. In order to de-couple the portable electronic device 100 and the mounting device 162, the force attracting the coupling member 146 and the accessory magnet 168 is overcome by pulling the portable electronic device 100 and the mounting device 162 away from one another. This physical separation of the portable electronic device 100 and the mounting device 162 can be achieved by a user without a need for tools. When the magnets 168 of the mounting device 168 have been moved sufficiently far from the coupling member 146, the coupling member 146 returns to the retracted position under the force of the biasing member 160.

The distance at which the coupling element 146 of the portable electronic device 100 begins to move toward the accessory magnet 168 may be determined based on the strength of the accessory magnet 168 relative to the strength of the biasing element 160. In one embodiment, the distance between the portable electronic device 100 and the mounting device 162 may be approximately 2.5 mm when the coupling element 146 begins to extend. Other distances are possible including distances greater than 2.5 mm and less than 2.5 mm.

Although the coupling members 146 are shown as having a circular cross-section, other shapes are possible. For example, the coupling members 146 may have any cross-sectional shape including: square, rectangular, oval, half-circle (or D-shaped) and triangular. The cross-sectional shape may also represent a logo or other irregular shape, for example. Any number of connectors 145 may be provided and may be located anywhere within the housing 140 of the portable electronic device 100. When more than one connector 145 is provided, the connectors 145 may have the generally identical cross-sectional shapes or different cross-sectional shapes.

Although the exposed end surface 152 is shown as being flush with the outer surface of the back panel 142 when in the retracted position, the coupling member 146 may instead be substantially below the outer surface of the back panel 142 or above the outer surface of the back panel 142.

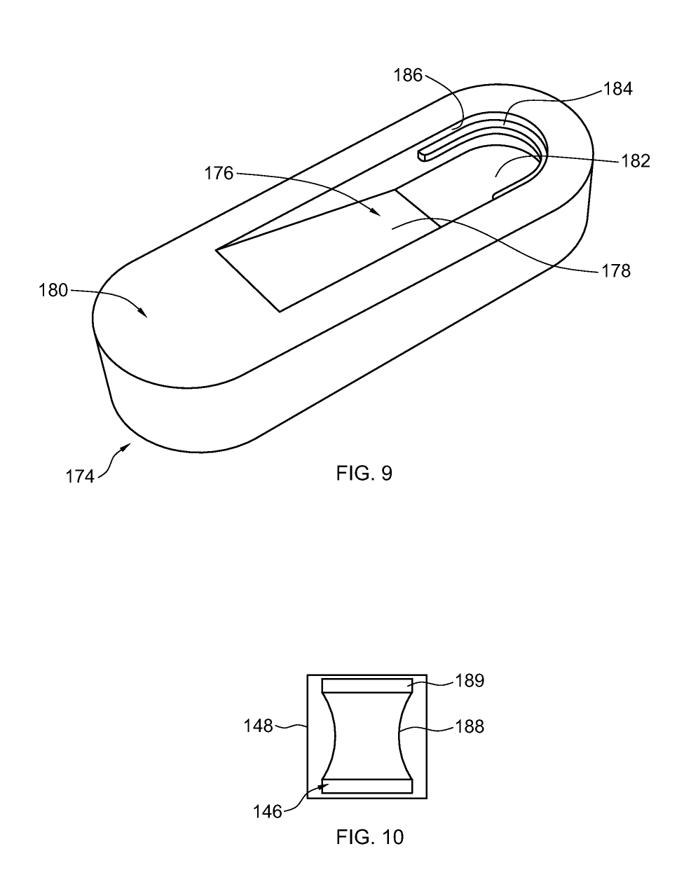

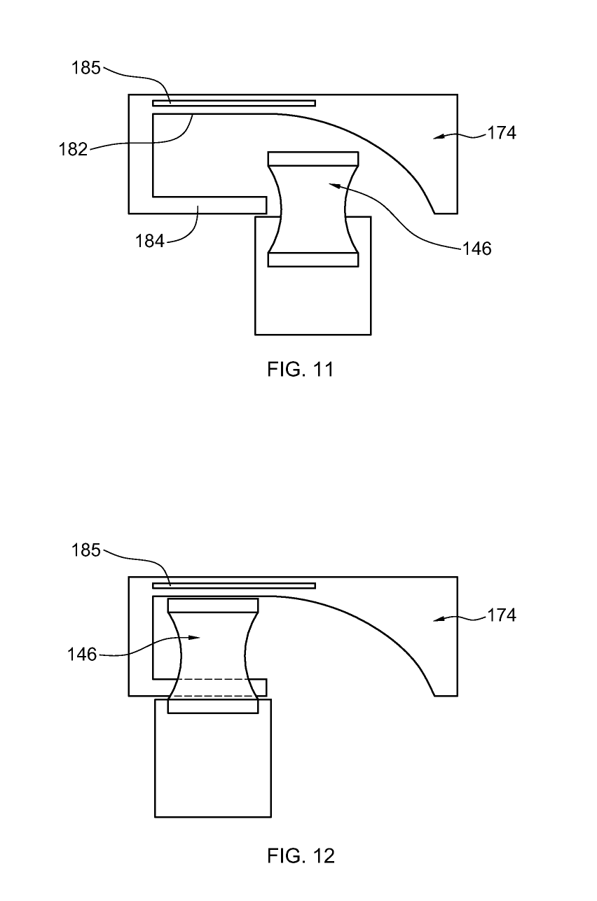

In another embodiment, an accessory may include one or more fittings for mating with respective coupling members 146. The one or more fittings may be nested in the accessory or coupled to an outer surface thereof. Referring to FIG. 9, a fitting 174 includes a recess 176 having a sloped surface 178 that extends between a portable electronic device-abutting surface 180 of the fitting 174 and a base surface 182. A locking rib 184 projects from a wall 186 of the recess 176. An external force element, such as a fitting magnet 185 (see FIGS. 11 and 12) is located inside the fitting 174 near (for example, close to, adjacent to, at, or built into) the base surface 182.

The fitting 174 of FIG. 9 is for use with a coupling member 146 having a groove 188 that extends about a circumference thereof, as shown in FIG. 10. Alternatively, the coupling member 146 shown in FIG. 10 may be thought of as having a flange 189 located on a fitting-abutting side of the coupling member 146. In operation, the coupling member 146 moves to the extended position in response to the force applied by the fitting magnet. The coupling member 146 is aligned with the recess 176 and moved from the portable electronic device-abutting surface 180 along the sloped surface 178 toward the base surface 182, as shown in FIG. 11. When the coupling member 146 reaches the base surface 182, the engagement between the locking rib 184 and the groove 188 (or the flange 189) of the coupling member 146 causes relative movement in any direction other than along the sloped surface 178 to be restricted. In this embodiment, the portable electronic device 100 and the accessory are held together based the relative strength of the fitting magnet and the engagement between the coupling member 146 and the locking rib 184.

In order to release the fitting 174 from the connector 145 of the portable electronic device 100, the attractive force between the coupling member 146 and the fitting magnet 185 is overcome and the connector 145 is moved relative to the fitting 174 along the sloped base 178 away from the base 182. When the magnet of the fitting 174 have been moved sufficiently far from the coupling member 146, the coupling member 146 returns to the retracted position under the force of the biasing member 160. Such physical coupling and decoupling may further constrain the freedom of motion of the coupled devices, and may restrict sliding as well as separation by mere pulling apart. Such physical coupling, in which there are physical constraints supplied by the recess 176 and the locking rib 184, may be advantageous where, for example, one device is hooked or hanging with respect to another, or where there may be an interest in avoiding accidental separation of the physically coupled devices.

The fitting need not be provided as a separate part and instead may be integrated into the accessory. Further, different components for providing secondary coupling/locking functionality in addition to the magnetic attraction between the device and accessory may be used. For example, rubber grommets may be provided at an entrance to the coupling member-receiving recess of the accessory.

In some embodiments, the coupling member 146 also functions as an electrical connector for transferring electrical signals between the portable electronic device 100 and an accessory and/or for recharging the power source 130. In such embodiments, electrical wiring may be provided between the coupling members 146 and the processor 102 and/or the power source 130 of the portable electronic device 100. As previously noted, some biasing members may be constructed of conductive materials, such as metal, that can serve as a current path.

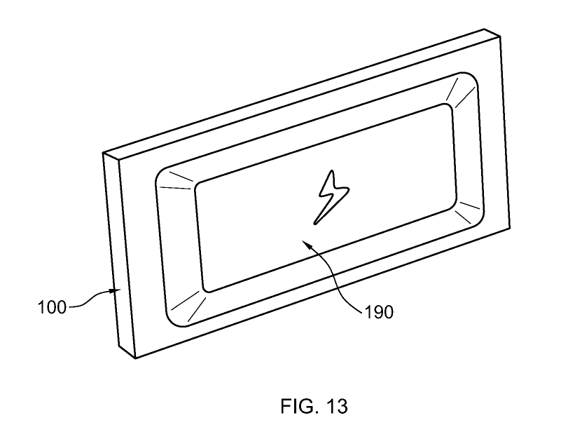

Referring to FIG. 13, the accessory is an external power pack 190 that is coupled to the portable electronic device 100. In this embodiment, the portable electronic device 100 includes one or more connectors 145 similar to those shown in FIGS. 4-6, which engage recesses located in a mating side of the external power pack 190, in a similar manner as described with respect to FIG. 8. When the external power pack 190 and the portable electronic device 100 are coupled to one another, the coupling member 146 is in electrical communication with the external power pack 190 and the processor 102 of the portable electronic device 100. One or more connectors 145 may couple the external power pack 190 and the portable electronic device 100. When a single connector 145 is provided on the portable electronic device 100, a stop or other mechanical element may be provided on the back panel 142 to limit rotation of the external power pack 190 relative to the portable electronic device 100.

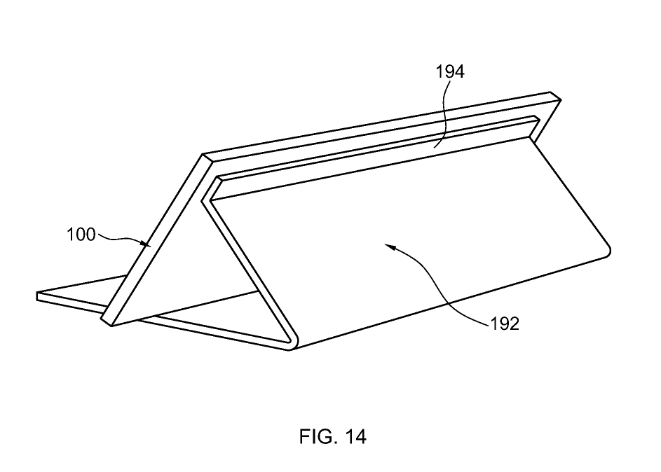

Referring to FIG. 14, the accessory is a cover 192 that is coupled to the portable electronic device 100. The cover 192 may also function as a stand, as shown in FIG. 14. In this embodiment, the portable electronic device 100 includes two or more connectors 145 similar to those shown in FIGS. 4-6, which engage recesses located in a mating flange 194 of the cover 192, in a similar manner as described with respect to FIG. 8.

Referring to FIG. 15, the accessory is a docking station 196 to which the portable electronic device 100 is coupled. In this embodiment, the portable electronic device 100 includes two connectors 145 similar to those shown in FIGS. 4-6, which engage recesses located in mating flanges 198 of the docking station 196, in a similar manner as described with respect to FIG. 8. The docking station 196 may be used to charge the portable electronic device 100 and/or send data to and receive data from the portable electronic device 100. When the docking station 196 and the portable electronic device 100 are coupled to one another, the coupling member 146 is in electrical communication with the docking station 196 and the processor 102 of the portable electronic device 100. The docking station 196 may include wiring 200 for coupling to a power source and/or a computer. Alternatively, the docking station 196 may not include any electrical capability and may function as a device support stand.

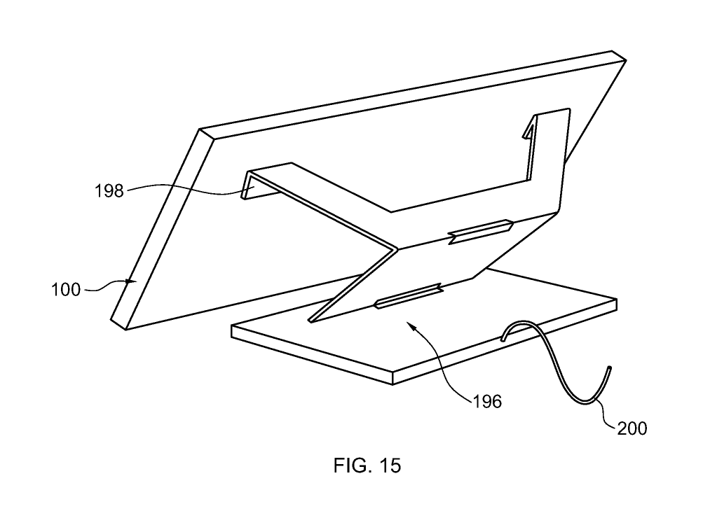

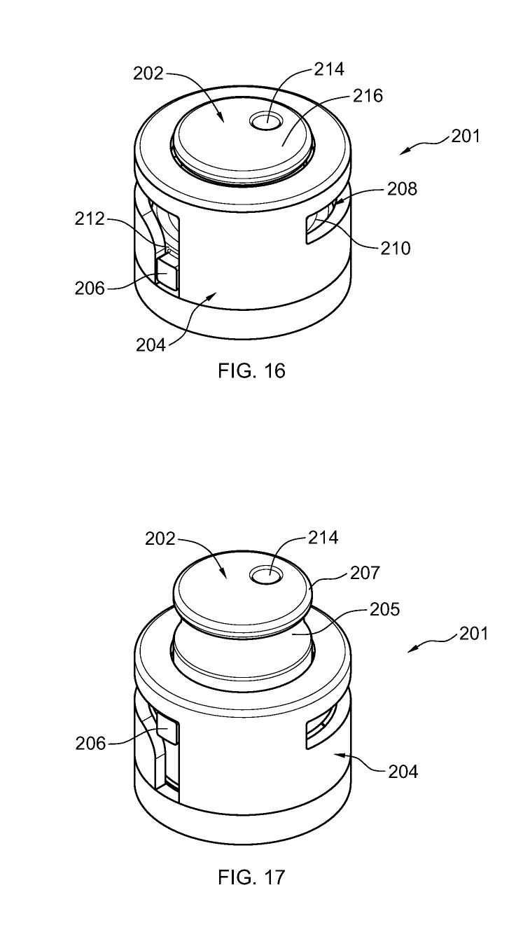

In another embodiment, which is shown in FIGS. 16 and 17, a connector 201 includes a coupling member 202 that may be locked in an extended position relative to a guide 204. The guide 204 may be mountable inside a housing 140 of a portable electronic device 100, in a similar manner as has been described with respect to the embodiment of FIGS. 4-6. In a variation, the guide 204 may be formed as a unitary structure with the materials forming the housing 140. The coupling member 202 includes a projection 206, which extends from a base thereof. The projection 206 is received in an opening (or slot) 208, which extends through a wall 210 of the guide 204. The opening 208 functions as a retainer to maintain the coupling member 202 within the guide 204, and also serves as a path along which the projection 206 may move. The projection 206 and opening 208 enable the coupling member 202 to extend and retract with respect to the guide 204 relatively freely in some places but not others, and to rotate with respect to the guide 204 relatively freely in some places but not others. The opening 208 includes a first portion 210 and a second portion 212. Extending and retracting motion of the coupling member 202 is possible when the projection 206 is received in the first portion 210 and is restricted when the projection 206 is received in the second portion 212. The coupling member 202 is movable from the extended position to an extended and locked position by rotating the coupling member 202 to move the projection 206 into the second portion 212 of the opening 208. A depression 214 is provided in an exposed end surface 216 of the coupling member 202. The depression 214 may be engaged by a tool in order to facilitate locking of the coupling member 202. The depression 214 is depicted for purposes of illustration; other physical structures, such as a Phillips screw drive or a cusp or textured surface, may perform the same or a similar function. In a further alternative, the coupling member 202 may be rotated by a user grasping and turning the coupling member 202 with fingers. As shown in FIG. 17, coupling member 202 optionally may include a groove 205 (or a flange 207), which would enable coupling member 202 to engage a fitting such as fitting 174 depicted in FIG. 9.

The coupling member 202 is movable from the retracted position of FIG. 16 to the extended position of FIG. 17 in a manner that has been described with respect to the other connector embodiments disclosed herein. When in the extended position, the coupling member 202 may be rotated to lock the coupling member 202 in the extended and locked position. Because it is possible to lock the coupling member 202 in the extended position, the portable electronic device 100 including a connector according to this embodiment may be coupled to accessories that do not include accessory magnets. For example, accessories that are sensitive to magnetism including accessories capable of wireless communication, such as WiFi or near field communication (NFC), may not include magnets. Where no magnet is present in the accessory, one alternative is to have a tool with a magnet, separate from the accessory, which can be used to extend the coupling member 202, or rotate the coupling member 202 into a locked position, or both. In a further variation, such a tool may be attached to the accessory.

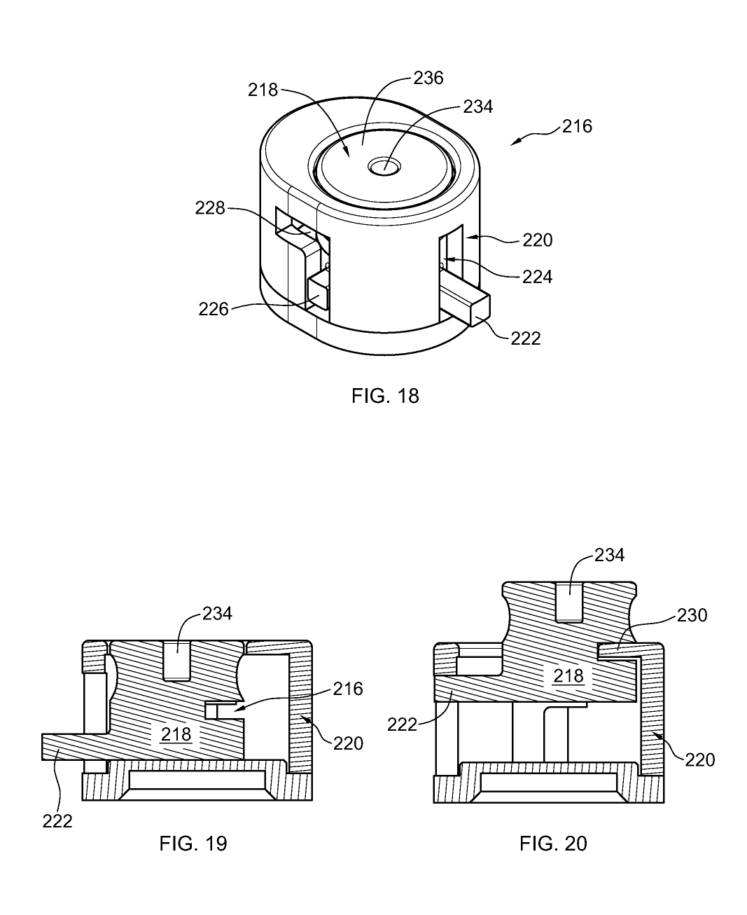

Referring to FIGS. 18, 19 and 20, another embodiment of a connector 216 including a coupling member 218 and a guide 220, in which the coupling member 218 may be locked in an extended position relative to the guide 220 is shown. The guide 220 may be mountable inside a housing 140 of a portable electronic device 100, in a similar manner as has been described with respect to the embodiment of FIGS. 4-6. As shown, the coupling member 218 includes a first projection 222, which extends through a first opening 224 in a wall of the guide 220, and a second projection 226, which extends through a second opening 228 in a wall of the guide 220. Together, the first projection 222 and the second projection 226 function as a retainer to maintain the coupling member 218 within the guide 220. The second opening 228 includes a first portion 230 and a second portion 232. Extending and retracting motion of the coupling member 218 is possible when the second projection 226 is received in the first portion 230 and is restricted when the second projection 206 is received in the second portion 232. The coupling member 218 is movable from the extended position to the extended and locked position by translating the coupling member 218 to move the second projection 226 into the second portion 232 of the second opening 228. In the extended and locked position, a groove 226 of the coupling member 218, which is located generally opposite to the first projection 222, receives an inwardly extending flange 230 of the guide 220 to maintain the coupling member 218 in the extended position. A depression 234 is provided in an exposed end surface 236 of the coupling member 218. The depression 234 may be engaged by a tool in order to facilitate locking of the coupling member 218. Alternatively, the coupling member 218 may be translated by a user grasping the coupling member 218 with fingers. Colloquially speaking, the coupling member 218 moves to an extended and locked position by extending and sliding, as contrasted with the coupling member 202 shown in FIGS. 16 and 17, which moves to an extended and locked position by extending and twisting or rotating.

The coupling member 218 is movable from the retracted position of FIGS. 18 and 19 to the extended position of FIG. 20 in a manner that has been described with respect to the other connector embodiments herein. When in the extended position, the coupling member 218 may be translated to lock the coupling member 218 in the extended and locked position. Similar to the embodiment of FIGS. 16 and 17, the portable electronic device 100 including a connector according to this embodiment may be coupled to accessories that do not include accessory magnets.

In another embodiment, instead of being made of a ferrous material, the coupling members 202, 218 may be magnets that are biased to remain within the guide by a spring or other biasing member. In this embodiment, the recess of the accessory includes a ferrous member to which the coupling member 202, 218 is attracted.

Although the concepts have been described in the context of an electronic device including a connector with a guide and a coupling member, it is contemplated that the connector may be included with an accessory. There may be one or more advantages for inclusion of the connector in the electronic device, however. An electronic device may connect to a variety of accessories. Also, in those embodiments in which a magnet is used to overcome the force of a biasing member and cause a coupling member to move into the extended position, the weight or bulk of the magnet may be more practically included in the accessory. Further, physically coupling and decoupling the electronic device may be more convenient or intuitive when the connectors are in the device rather than the accessory. Also, many of the embodiments of connectors can be implemented with components of small size or weight, which may be of significance especially when an electronic device is handheld.

The connector of the portable electronic device described herein may realize one or more advantages, some of which may have already been described. Because the coupling member of the connector is biased to the retracted position in which the exposed end surface is flush with the surface of the housing, the electronic device may have a sleek and streamlined (and otherwise aesthetically pleasing) appearance, and the connector may be generally protected from damage. Further, the surface of the electronic device at the connector location is comparatively smooth, generally avoiding clothing or fabric snags resulting from contact with the electronic device. A further possible advantage of the described embodiments is that because the clearance between the coupling member and the aperture is small, dirt is generally prevented from entering the housing. In addition, various embodiments enable the coupling members to be extended and retracted readily easily, yet the coupling members can be physically robust. The coupling members can securely anchor an electronic device to an accessory (or vice versa) or can restrict or reduce the risk of undesirable movement of the device relative to the accessory. The coupling members also enable the electronic device to be readily detached from the accessory, and the coupling members to be readily stowed in a retracted position.

The above-described embodiments are intended to be examples only. Alterations, modifications and variations can be effected to the particular embodiments by those of skill in the art without departing from the scope of the present application, which is defined solely by the claims appended hereto.

What is claimed is:

1. An electronic device comprising:
a housing, a panel of the housing comprising an aperture;
a connector mounted within the housing, the connector comprising:
a guide aligned with the aperture;
a coupling member slidably received in the guide and movable between a retracted position in which a base end surface of the coupling member abuts a seat of the guide and an extended position, the coupling member biased toward the retracted position and the coupling member movable toward the extended position in response to a magnetic force that exceeds a biasing force applied by a biasing member, the coupling member extending through the aperture and retained in the guide when in the extended position.

2. The electronic device of claim 1, wherein the coupling member comprises a ferrous material.

3. The electronic device of claim 1, wherein the coupling member comprises a magnet.

4. The electronic device of claim 1, wherein a cross-section of the coupling member is circular.

5. The electronic device of claim 1, wherein the guide comprises a wall extending between the housing and the seat.

6. The electronic device of claim 1, comprising an input device mounted in the housing, the input device in communication with the processor.

7. The electronic device of claim 6, wherein the input device is a touch-sensitive display.

8. The electronic device of claim 1, wherein the biasing member is a magnet.

9. The electronic device of claim 1, wherein the biasing member is a spring coupled between the coupling member and the seat.

10. The electronic device of claim 1, wherein the coupling member is retained in the housing by a projection extending from a base of the coupling member, the projection received in an opening of the guide.

11. The electronic device of claim 1, wherein the coupling member is receivable in a recess of a device accessory, an accessory magnet for generating the magnetic force located near the recess.

12. The electronic device of claim 1, wherein the coupling member is an electrical connector.

13. The electronic device of claim 1, wherein the coupling member is lockable in the extended position.

14. The electronic device of claim 1, comprising a second connector.

15. The electronic device of claim 1, wherein the coupling member comprises a coating.

16. The electronic device of claim 1, wherein the coupling member comprises a flange for mating with a locking rib of a fitting to restrict movement of the coupling member relative to the fitting.

17. The electronic device of claim 16, wherein the fitting is for coupling to a device accessory.

18. The electronic device of claim 1, wherein an exposed end surface of the coupling member is flush with an outer surface of the panel when in the retracted position.

19. The electronic device of claim 1, wherein the coupling member is lockable in the extended position by rotating the coupling member relative to the guide.

20. The electronic device of claim 1, wherein the coupling member is lockable in the extended position by sliding the coupling member relative to the guide.
